(19) United States
(12) Patent Application Publication
(10) Pub. No.: US 2026/0273500 A1
(43) Pub. Date: Sep. 17, 2026

(54) REACTOR WITH COUNTER HELICAL FLOW CHANNELS AND METHOD OF USING SAME

(71) Applicant: CORNING INCORPORATED, CORNING, NY (US)

(72) Inventor: Elena Daniela Lavric, Avon (FR)

(21) Appl. No.: 19/480,137

(22) PCT Filed: Jun. 4, 2024
(86) PCT No.: PCT/US2024/032337

§ 371 Date: Oct. 30, 2025

Related U.S. Application Data
(60) Provisional application No. 63/471,330, filed on Jun. 6, 2023.

(51) Int. Cl. B01J 19/24; B01J 8/02; B01J 8/06

(52) U.S. Cl. CPC B01J 19/243; B01J 8/0271; B01J 8/06; B01J 2219/00083; B01J 2219/2423; B01J 2219/3325

(57) ABSTRACT

Embodiments of the disclosure relate to a reactor. The reactor includes a first helical channel having a plurality of first turns and a second helical channel having a plurality of second turns. The plurality of second turns of the second helical channel alternate with the plurality of first turns of the first helical channel. The reactor also includes a permeable membrane that divides the p-first helical channel into a first passage and a second passage along a length of the first helical channel. The permeable membrane is configured to control a flow of fluid between the first passage and the second passage.

### CROSS REFERENCE TO RELATED APPLICATIONS

This application claims the benefit of priority under 35 U.S.C. § 119 of U.S. Provisional Application No. 63/471,330 filed Jun. 6, 2023, the content of which is incorporated herein by reference in its entirety.

### BACKGROUND

The disclosure relates to flow reactors and, more particularly, to flow reactors having helical process and heat exchange channels.

Continuous flow reactors are being more popular for industrial scale chemical processes. Within such reactors, continuous streams of reactants react to provide a continuous stream of products. Continuous flow reactors are able to handle high reactant concentrations and provide high mixing rates. Because of these advantages, continuous flow reactors have found use in the food, chemical, and pharmaceutical industries.

### SUMMARY

According to an aspect, embodiments of the disclosure relate to a reactor. The reactor includes a first helical channel having a plurality of first turns and a second helical channel having a plurality of second turns. The plurality of second turns of the second helical channel alternates with the plurality of first turns of the first helical channel. The reactor also includes a permeable membrane that divides the first helical channel into a first passage and a second passage along a length of the first helical channel. The permeable membrane is configured to control a flow of fluid between the first passage and the second passage.

According to another aspect, embodiments of the disclosure relate to a reactor. The reactor includes a first helical channel having a plurality of first turns and a second helical channel having a plurality of second turns. The plurality of second turns of the second helical channel alternates with the plurality of first turns of the first helical channel. A catalyst is disposed within the first helical channel, and the catalyst is configured to promote a reaction in fluid flowing through the first helical channel.

According to still another aspect, embodiments of the disclosure relate to a method. In the method, a first fluid flows through a first helical channel that has a plurality of first turns winding around a longitudinal axis. A second fluid flows through a second helical channel that has a plurality of second turns winding around the longitudinal axis. The plurality of second turns of the second helical channel alternates with the plurality of first turns of the first helical channel. A reaction in the first fluid is catalyzed using a catalyst disposed in the first helical channel.

According to a further aspect, embodiments of the disclosure relate to a method. In the method, a first fluid flows through a first passage of a first helical channel. The first helical channel has a plurality of first turns winding around a longitudinal axis. Further, in the method, a second fluid flows through a second passage of the first helical channel. A permeable membrane separates the first passage from the second passage along a length of the first helical channel. A third fluid flows through a second helical channel that has a plurality of second turns winding around the longitudinal axis. The plurality of second turns of the second helical channel alternates with the plurality of first turns of the first helical channel. A flow of the second fluid into the first fluid is controlled using the permeable membrane.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIGS. 1-3 depict reactors having helical channels with various pitches between the turns of the channel, according to exemplary embodiments;

FIG. 4 depicts a reactor having helical channels with a reversed flow as compared to FIG. 1, according to an exemplary embodiment;

FIGS. 5A and 5B depict reactors having a helical channel with a variable flow area, according to an exemplary embodiment;

FIGS. 6 and 7 depict contours of the helical channel designed to affect the magnitude of the velocity field, according to an exemplary embodiment;

FIGS. 8A and 8B depict a cross-sectional view of turns of adjacent helical channels designed to facilitate heat transfer, according to an exemplary embodiment;

FIG. 9 depicts a reactor having a central tube and an outer shell to provide additional thermal management, according to an exemplary embodiment;

FIGS. 10A and 10B depict examples of a catalyst disposed in a first helical channel of a reactor, according to an exemplary embodiment;

FIG. 11 depicts a first helical channel containing a permeable membrane that divides the first helical channel into a first passage and a second passage, according to an exemplary embodiment;

FIG. 12 depicts a reactor having taps to remove gaseous byproducts from the first helical channel, according to an exemplary embodiment;

FIG. 13 is a graph of modeled pressure drop as a function of flow rate based on the reactor designs of FIGS. 1-5, according to exemplary embodiments;

FIG. 14 is a graph of modeled pressure drop as a function of flow rate based on reactors having various diameters, according to exemplary embodiments;

FIGS. 15 and 16 depict flow velocity fields based on the reactor designs of FIGS. 1 and 5, according to exemplary embodiments;

FIG. 17 is a graph of volumetric heat transfer coefficient for a toluene/silicone oil system, according to exemplary embodiments;

FIG. 18 depicts a prototype of a reactor, according to an exemplary embodiment;

FIG. 19 is a graph of the volumetric mass transfer coefficient as a function of residence time for a liquid-gas system, according to an exemplary embodiment; and

FIG. 20 is a graph of the volumetric mass transfer coefficient and pressure drop as a function of residence time, according to an exemplary embodiment.

### DETAILED DESCRIPTION

Reference will now be made in detail to various embodiments of a reactor having helical channels configured to provide improved thermal conductivity between and enhanced mixing. In particular, the reactor can be modified in a variety of ways to vary velocity fields of the fluid flow in both direction and magnitude, improve thermal management, catalyze reactions, and enhance contact between precursors. For example, the pitch, shape, and contours of the helical channel can be adjusted to increase/decrease residence time or accelerate/decelerate flow rate. Further, the helical channel can be coated or packed with a catalyst or divided by a permeable membrane to adjust the kinetics of the reaction in the helical channel. These and other aspects and advantages of the reactor having helical channels will be described in relation to the embodiments provided below and depicted in the figures. These embodiments are presented by way of illustration and not by way of limitation.

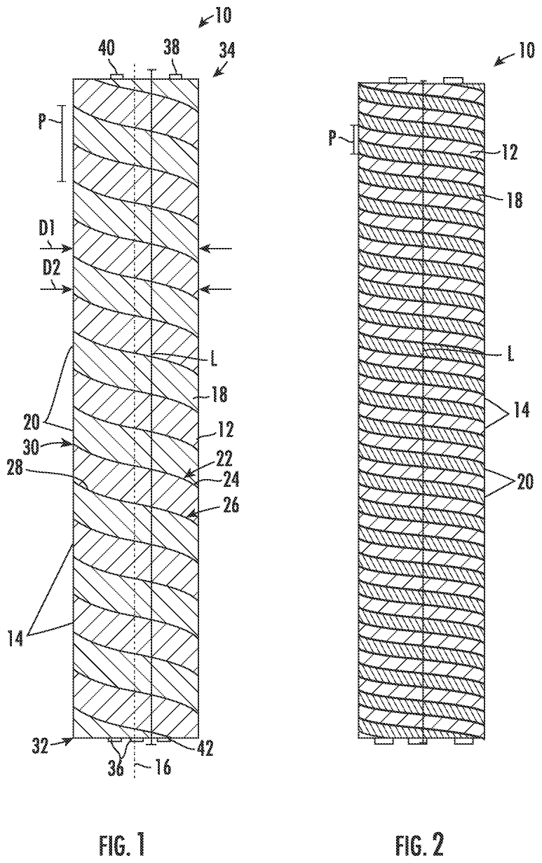

FIG. 1 depicts an embodiment of a reactor 10. The reactor 10 includes a first helical channel 12 through which at least one first fluid flows. In one or more embodiments, two or more first fluids flow in the first helical channel 12, and in the first helical channel 12, the two or more first fluids react or combine to form a product stream. The first helical channel 12 includes a plurality of first turns 14 that wind the first helical channel 12 around a longitudinal axis 16 of the reactor 10. As used herein, a “turn” is a complete rotation (e.g., 360 degrees) around the longitudinal axis 16 in which a starting point of the turn is axially displaced along the longitudinal axis 16 from an ending point of the turn. In one or more embodiments, the first turns 14 wind in a continuous curve around the longitudinal axis such that the first turns 14 define a circular, elliptical, oval, or other curved shape when the reactor 10 is viewed from above. In one or more other embodiments, the first turns 14 wind in substantially linear segments (with rounded or sharp vertices) around the longitudinal axis 16 such that the first turns 14 define a triangular, quadrilateral, or other polygonal shape when the reactor is viewed from above. In still one or more other embodiments, the first turns 14 wind in both curved and linear segments around the longitudinal axis 16 such that the first turns define shapes having both curved and linear regions (e.g., a racetrack shape). Each first turn 14 has a first maximum cross-sectional dimension D1, and in one or more embodiments, the first maximum cross-sectional dimension D1 is centered on the longitudinal axis 16. In the embodiment depicted, the first turns 14 define a circular helix having a first maximum cross-sectional dimension (diameter) D1 that is centered on the longitudinal axis 16.

The reactor 10 also includes a second helical channel 18 through which at least one second fluid flows. In the figures, opposing hatching is used to distinguish between the first helical channel 12 and the second helical channel 18 (for non-cross section views). In one or more embodiments, the at least one second fluid is a heat exchange fluid that is configured to heat or cool the at least one first fluid in the first helical channel 12, e.g., to promote mixing, reacting, etc. of the fluid in the first helical channel 12. Notwithstanding, in one or more other embodiments, the at least one second fluid can be selected to use heat generated by the first fluid of the first helical channel 12 to carry out a reaction or to produce heat to promote a reaction in the first fluid of the first helical channel 12. Thus, for example, an exothermic reaction may be carried out in the first helical channel 12, and an endothermic reaction may be carried out in the second helical channel 18 (or vice versa).

The second helical channel 18 includes a plurality of second turns 20. As with the first helical channel 12, a “turn” 20 of the second helical channel 18 is a complete rotation (e.g., 360 degrees) around the longitudinal axis 16 in which a starting point of the turn is axially displaced along the longitudinal axis 16 from an ending point of the turn. In one or more embodiments, the second turns 20 wind in a continuous curve around the longitudinal axis such that the second turns 20 define a circular, elliptical, oval, or other curved shape when the reactor 10 is viewed from above. In one or more other embodiments, the second turns 20 wind in substantially linear segments (with rounded or sharp vertices) around the longitudinal axis 16 such that the second turns 20 define a triangular, quadrilateral, or other polygonal shape when the reactor is viewed from above. In still one or more other embodiments, the second turns 20 wind in both curved and linear segments around the longitudinal axis 16 such that the second turns 20 define shapes having both curved and linear regions (e.g., a racetrack shape). Each second turn 20 has a second maximum cross-sectional dimension D2, and in one or more embodiments, the second maximum cross-sectional dimension D2 is centered on the longitudinal axis 16. In the embodiment depicted, the second turns 20 also define a circular helix having a second maximum cross-sectional dimension (diameter) D2 that is centered on the longitudinal axis 16.

In one or more embodiments, the second maximum cross-sectional dimension D2 equals the first maximum cross-sectional dimension D1. However, in one or more other embodiments, the second maximum cross-sectional dimension D2 is different (larger or smaller) than the first maximum cross-sectional dimension D2.

As shown in FIG. 1, the plurality of second turns 20 of the second helical channel 18 alternate with the plurality of first turns 14 of the first helical channel 12. In this way, a second turn 20 is disposed between subsequent first turns 14.

In one or more embodiments, the at least one first fluid that flows through the first helical channel 12 comprises a liquid, a gas, a slurry, or a combination thereof. In one or more embodiments, the second fluid that flows through the second helical channel 18 comprises a liquid, a gas, a slurry, or a combination thereof.

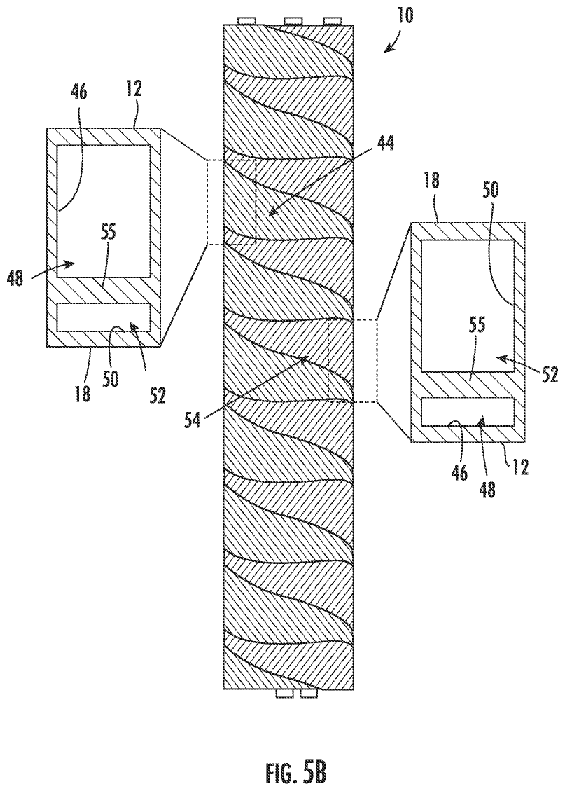

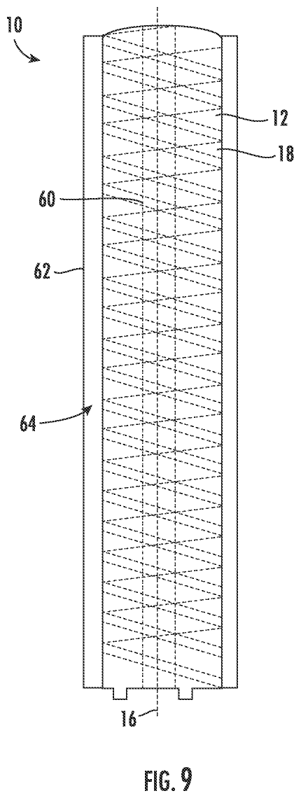

In one or more embodiments, the first helical channel 12 is defined by a first wall 22 having a first outer surface 24. Further, in one or more embodiments, the second helical channel 18 is defined by a second wall 26 having a second outer surface 28. In one or more embodiments, the first outer surface 24 is in contact with the second outer surface 28. In particular, the first outer surface 24 is in contact with the second outer surface 28 at interfaces 30 between the first turns 14 and the second turns 20 along the length of the first helical channel 12 and the second helical channel 18. In such embodiments, the contact between the surfaces 24, 28 of the helical channels 12, 18 improves thermal conductivity between the helical channels 12, 18 (e.g., the second channel 18 more effectively heats or cools the first helical channel 12). Notwithstanding, in one or more other embodiments, the first helical channel 12 shares a common wall with the second helical channel 18 (e.g., as shown in FIGS. 5B and 8B).

As shown in FIG. 1, the reactor 10 has a length L along the longitudinal axis 16 between a first end 32 and a second end 34. The length L of the reactor 10 is not particularly limited, and in one or more embodiments, the length L is from 1 mm to 10,000 mm, in particular from 100 mm to 5000 mm. In one or more embodiments, the first helical channel 12 includes at least one first inlet 36 at the first end 32 and a first outlet 38 at the second end 34. In one or more embodiments, the first helical channel 12 includes two or more first inlets 36 to receive two fluid streams, and the fluids react within the first helical channel 12 and exit the first outlet 38.

Further, in one or more embodiments, the second helical channel 18 includes a second inlet 40 at the second end 34 and a second outlet 42 at the first end 32. As mentioned above, in one or more embodiments, a heat exchange fluid flows through the second helical channel 18 from the second inlet 38 to the second outlet 40. Because the first inlet 36 of the first helical channel 12 is arranged at an opposite end from the second inlet 40 of the second helical channel 18, the reactor 10 may be configured for counter-helical flow in one or more embodiments, which enhances heat transfer between the first helical channel 12 and the second helical channel 18. Notwithstanding, the first inlet 36 of the first helical channel 12 and the second inlet 40 of the second helical channel 18 can be arranged at the same end such that fluid flows concurrently through the first helical channel 12 and the second helical channel 18 from the first end 32 to the second end 34 (or from the second end 34 to the first end 32).

The shape of the helical channels 12, 18 varies in different embodiments. For example, the helical channels 12, 18 can vary in pitch or cross-sectional flow area. As shown in FIG. 1, pitch P relates to the spacing between first turns 14 of the first helical channel 12 and between second turns 20 of the second helical channel 18. In one or more embodiments, the pitch P is from 1 mm to 10,000 mm, in particular from 10 mm to 100 mm. For a given length L, the pitch P determines the number of first turns 14 of the first helical channel 12, and a larger pitch P spacing corresponds to fewer first turns 14. In one or more embodiments, the second helical channel 18 has the same pitch P between the second turns 20 as the pitch P between the first turns 14. In one or more embodiments, the pitch P is constant along the length L of the reactor 10, and in one or more other embodiments, the pitch P varies along the length L of the reactor 10.

FIGS. 1-3 depict examples of reactors 10 having different pitches P between the turns 14, 20 of the helical channels 12, 18. FIG. 1 depicts a base case in which the pitch P is X (e.g., 60 mm). FIG. 2 depicts a reduced pitch case in which the pitch P is 0.5X (e.g., 30 mm), and as can be seen, the number of turns 14, 20 over the length L increases as compared to the base case. FIG. 3 depicts an increased pitch case in which the pitch P is 2× (e.g., 120 mm), and as can be seen, the number of turns 14, 20 over the length L decreases as compared to the base case. While each of FIGS. 1-3 depicts a constant pitch P over the length of the reactor 10, the pitch P can be variable along the length of the reactor 10 as mentioned above. For example, the pitch P may be shorter near the first inlet 36 and longer towards the first outlet 38 so that increasing residence time compensates for the decrease in the driving force of the chemical process. Additionally, a longer pitch P can be used where the reactor 10 is part of a multi-step process or when (chemical) quenching to compensate for the increase of the flow rate and limit the increase of the pressure drop. Moreover, a longer pitch P can be used when the heat transfer rate becomes less important (lower chemical driving force), so a decrease in pressure drop is beneficial, from an energetic point of view.

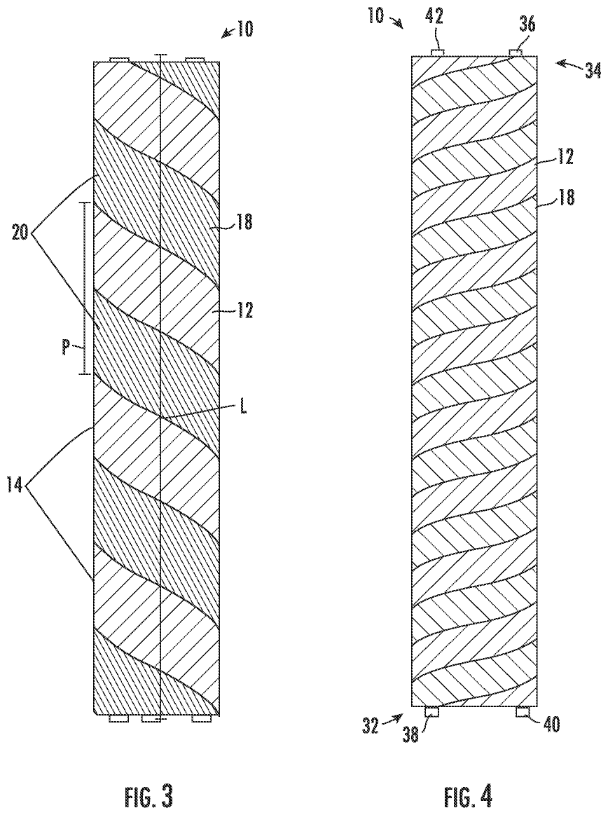

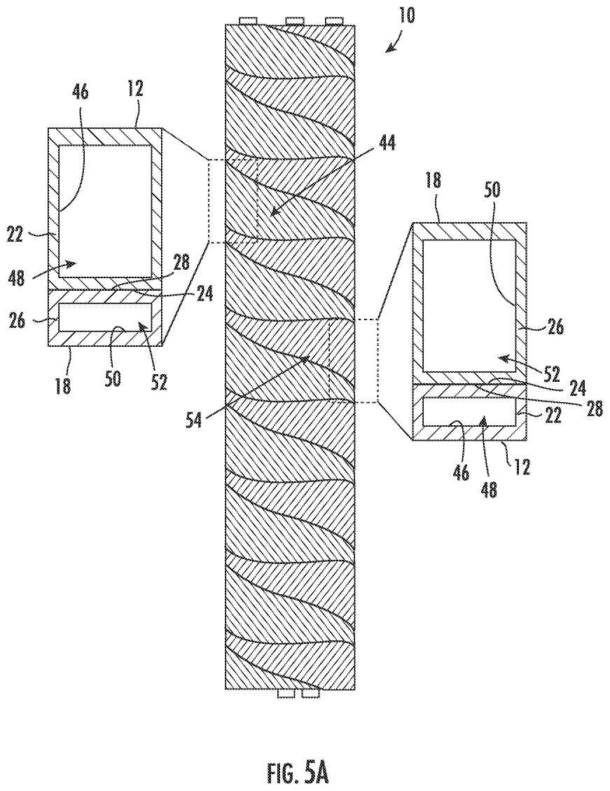

FIG. 4 depicts an embodiment in which the flow through the reactor 10 is reversed as compared to the embodiments shown in FIGS. 1-3. In FIG. 4, the at least one first inlet 36 of the first helical channel 12 is disposed at the second end 34 of the reactor 10, and the first outlet 38 of the first helical channel 12 is disposed at the first end 32 of the reactor 10. Correspondingly, the second inlet 40 of the second helical channel 18 is disposed at the first end 32 of the reactor, and the second outlet 42 of the second helical channel 18 is disposed at the second end 34 of the reactor 10. In the embodiment depicted, the flow in the respective helical channels 12, 18 remains counter, but the direction of each flow in FIG. 4 is reversed compared to the embodiments shown in FIGS. 1-3.

Besides the pitch P, the cross-sectional flow area of the helical channels 12, 18 can vary along the length of the helical channels 12, 18 as shown in FIGS. 5A and 5B. In FIG. 5A, the cross-sectional flow area of the first helical channel 12 varies inversely with the cross-sectional flow area of the second helical channel 18. For example, at a first location 44, the first helical channel 12 has a first inner surface 46 that defines a first flow area 48. At the first location 44, the second helical channel 18 has a second inner surface 50 that defines a second flow area 52. As can be seen, the second flow area 52 is smaller than the first flow area 48. At a second location 54, the first flow area 48 defined by the first inner surface 46 is less than the second flow area 52 defined by the second inner surface 50.

By increasing and decreasing the first flow area 48 in the first helical channel 12, the flow rate within the first helical channel 12 accelerates and decelerates to promote mixing of the fluid or fluids in the first helical channel 12. This can help make the temperature within a fluid or fluids more uniform and/or enhance the contact between different fluids and their reactants.

As shown in FIG. 5A, the first helical channel 12 is defined by the first wall 22, and the second helical channel 18 is defined by the second wall 26. As can be seen, the first outer surface 24 of the first wall 22 is in contact with the second outer surface 28 of the second wall 26, which as discussed above improves the thermal conductivity between the first helical channel 12 and the second helical channel 18. As shown in FIG. 5B, the first helical channel 12 and the second helical channel 18 have a common wall 55. In this way, the common wall 55 defines in part the first inner surface 46 of first helical channel 12 and defines in part the second inner surface 50 of the second helical channel 18. The common wall 55 also provides enhanced thermal conductivity between the first helical channel 12 and the second helical channel 18.

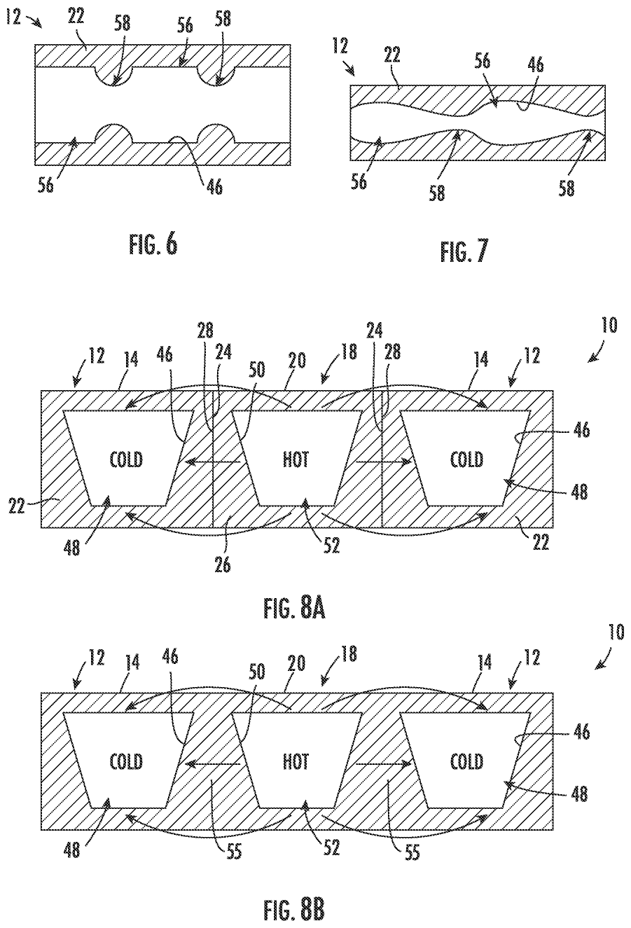

FIGS. 6 and 7 depict examples of contours of the first inner surface 46. In FIG. 6, the first inner surface 46 includes first regions 56 having a constant flow area and necked regions 58 disposed between the first regions 56. In one or more embodiments, the necked regions 58 taper in flow area from a maximum flow area in one first region 56 to a minimum flow area, e.g., at a midpoint of the necked region 58, and expand back to the maximum flow area in another first region 56. In FIG. 7, the flow area is constantly changing between first regions 56 of maximum flow area and necked regions 58 of minimum flow area.

In general, the shape and contours of the first helical channel 12 are designed to vary the velocity fields of the fluid flowing through first helical channel 12. The helical flow introduces directional changes to the velocity fields through centrifugal forces imparted on the fluid as it flows around the longitudinal axis 16. Further, the shape of flow area, including any contours, change the magnitude of the velocity fields, e.g., by speeding up or slowing down the flow.

Additionally, the design of the reactor 10 enhances heat transfer to/from the heat exchange fluid carried in the second helical channel 18. FIGS. 8A and 8B each depict a cross-section of helical channels 12, 18 taken through adjacent turns 14, 20 of the helical channels 12, 18. As shown in FIG. 8A, the first outer surface 24 of the first helical channel 12 is in contact with the second outer surface 28 of the second helical channel 18. The contact between the outer surfaces 24, 28 of the helical channels 12, 18 provides good thermal conductivity between the helical channels 12, 18, especially where the walls 22, 26 of the helical channels 12, 18 were made of high thermal conductivity materials (such as metals).

FIG. 8A also depicts helical channels 12, 18 having walls 22, 26 that are not uniformly thick. In particular, the inner surfaces 46, 50 define polygonal shapes (e.g., a trapezoid) that produces sections of the walls 22, 26 that are thicker than other sections. While a trapezoid is depicted, the inner surfaces 46, 50 may define other polygonal or rounded shapes. Further, while the embodiments depicted thus far consider helical channels 12, 18 in which the volume and channel shape/contour are the same, the first helical channel 12 can differ from the second helical channel 12 in at least one of volume, channel shape, or contour design.

In FIG. 8B, the reactor 10 has a common wall 55 between the helical channels 12, 18. As can be seen in FIG. 8B, the common wall 55 has a non-uniform thickness to provide a solid path of thermal conductivity between the helical channels 12, 18 despite the shape of the helical channels 12, 18.

While thermal management of the helical channels 12, 18 can be enhanced by promoting thermal conductivity, further provision can be made to heat or cool the first helical channel 12 as shown in FIG. 9. As discussed above, the first and second helical channels 12, 18 wind around a longitudinal axis 16 of the reactor 10. The center bore defined by the helical channels 12, 18 may be hollow such that there is nothing provided on the interior of the reactor 10. However, in one or more other embodiments, the reactor 10 comprises a central tube 60 through which additional heat exchange fluid can flow to heat or cool the fluid in the first helical channel 12. Further, in one or more embodiments, the reactor 10 is provided with an outer shell 62 that defines a cavity 64 around the helical channels 12, 18. This cavity 64 can also be filled with heat exchange fluid to heat or cool the fluid in the first helical channel 12. Thus, the reactor can be provided with additional thermal management using one or both of the central tube 60 and the outer shell 62.

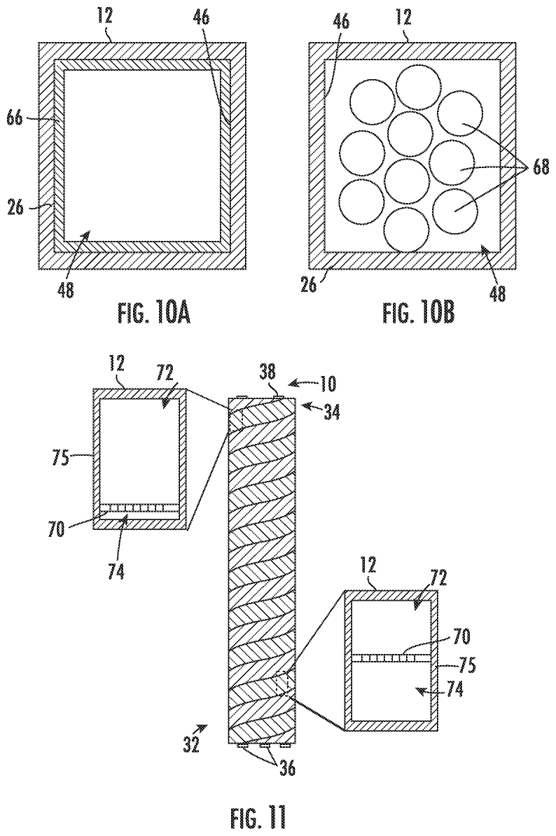

Besides controlling the reaction and/or mixing in the first helical channel 12 through thermal management, the reactor 10 also allows for control of reactions and mixing through other means. In one or more embodiments, the reactor 10 includes a catalyst in the first helical channel 12 as shown in FIGS. 10A and 10B. In FIG. 10A, the solid catalyst is a coating 66 deposited on the first inner surface 46. In one or more embodiments, the solid catalyst can be deposited using any of a variety of vapor deposition techniques known in the art. In FIG. 10B, the solid catalyst is provided in the form of beads or pellets 68 that are packed into the first helical channel 12. As can be seen, the beads or pellets 68 do not totally block the flow area of the first helical channel 12, and the flow through the beads or pellets 68 can be tailored based on the selection of the size or shape of the beads or pellets 68. In one or more embodiments, the catalyst can be used to catalyze such reactions as hydrogenation reactions, halogenation reactions, oxidation reactions, polymerization reactions, nitration reactions, esterification reactions, or fermentation reactions, among others.

According to one or more other embodiments, the reaction/mixing of the fluid in the first helical channel 12 can be controlled using a permeable membrane 70 that divides the first helical channel 12 along its length from the first end 32 to the second end 34 as shown in FIG. 11. In one or more embodiments, the permeable membrane 70 divides the first helical channel 12 into a first passage 72 and a second passage 74. In such embodiments, the first passage 72 may be in fluid communication with one first inlet 36, and the second passage 74 may be in fluid communication with another first inlet 36. In this way, the first passage 72 can receive a first fluid precursor, and the second passage 74 can receive a second fluid precursor. The permeable membrane 70 can be structured to control how the second fluid precursor interacts with the first fluid precursor. For example, the permeable membrane 70 may have pores that affect how much of the second precursor passes through the permeable membrane 70 to the first passage 72 along the length of the first helical channel 12. Further, the pore size may only allow droplets or bubbles of a certain size to pass through the permeable membrane 70.

In these ways, the permeable membrane 70 can control the reaction kinetics by increasing or decreasing the surface area of one precursor in another. That is, the permeable membrane 70 can restrict passage of the second precursor to bubbles or droplets below a certain size to increase the surface area of the second precursor in the first precursor. Further, the permeable membrane 70 can control how much second precursor passes through at a time. If too much second precursor passes through at a time, then the second precursor may coalesce and drift to the outer edges of the first helical channel 12 because of centrifugal forces.

Further, in one or more embodiments, the permeable membrane 70 tapers along the length of the first helical channel 12. In this way, the ratio of the flow area in the first passage 72 to the flow area in the second passage 74 changes along the length of the first helical channel 12. For example, the ratio of flow area in the first passage to second passage may change from 50:50 at the first end 32 to 100:0 at the second end 34. In such an embodiment, the first passage 70 may be in fluid communication with the first outlet 38.

Further, in one or more embodiments, an external wall 75 or a portion thereof is also a membrane 70. In this way, fluid in the first helical channel 12 can be fed continuously into another component. For example, the membrane 70 can select desired products or undesired byproducts for feeding into another component, e.g., for further reaction or storage/removal.

In another embodiment, the reaction kinetics in the first helical channel 12 can be controlled by removing gaseous byproducts as shown in FIG. 12. In certain chemical reactions, a gas may be produced along with a desired chemical product, and the presence of the gas within the fluid stream shortens the residence time of the liquid phase in the first helical channel 12 and affects the heat transfer intensity. Thus, as shown in FIG. 12, the reactor 10 may be provided with one or more taps 76 through which gas can escape the liquid phase within the first helical channel 12.

### Modeled Experimental Examples

Various embodiments of the disclosed reactor 10 were modeled to determine flow characteristics.

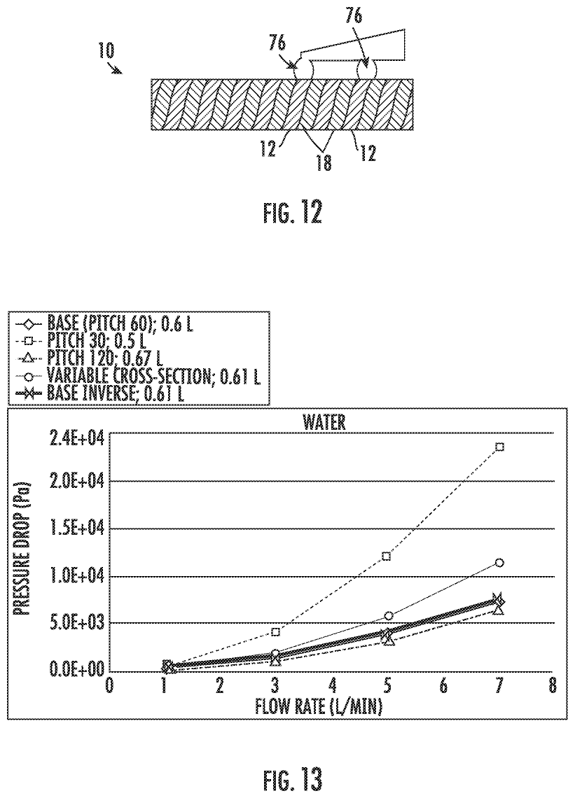

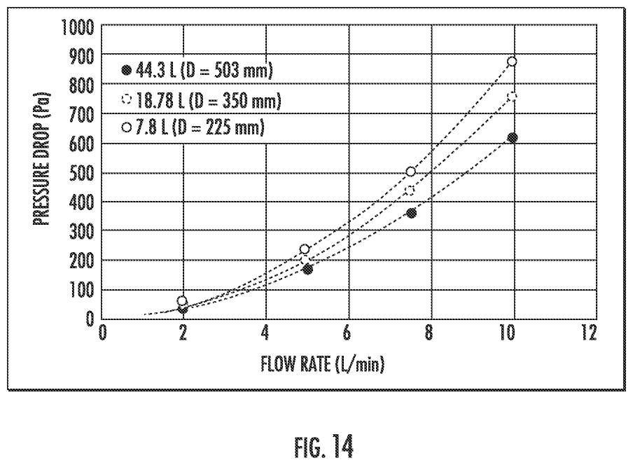

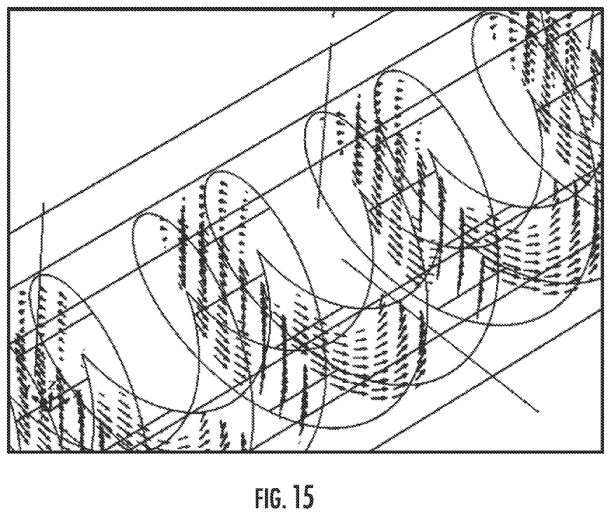

FIG. 13 is a graph of pressure drop as a function of flow rate. The modeled data considered a reactor 10 with a diameter of 75 mm and a length of 400 mm for reactor embodiments according to FIGS. 1-5. In particular, the base pitch P as shown in FIG. 1 was 60 mm (volume of 0.6 L). The small pitch P as shown in FIG. 2 was 30 mm (volume of 0.5 L), and the large pitch P as shown in FIG. 3 was 120 mm (volume of 0.67 L). The inverse flow reactor 10 had the base pitch of 60 mm (volume of 0.61 L), and the variable flow area reactor 10 as shown in FIG. 5 has a volume of 0.61 L. The fluid considered in the models was water. As can be seen in FIG. 13, the reactor 10 with the largest pitch had the lowest pressure drop. The reactors with the base pitch and the inverse base pitch had the same pressure drop for the flow rates modeled, which was slightly higher than for the largest pitch. The variable cross-section was slightly higher than base pitch and inverse base pitch reactors 10, and the small pitch reactor had the highest pressure drop. Notwithstanding, all of the modeled reactors exhibited a pressure drop of less than 0.25 bar.

FIG. 14 is a graph of the pressure drop as a function of flow rate for reactors having different diameters, but keeping the same pitch P. Specifically, the diameters of 225 mm, 350 mm, and 503 mm were considered, which corresponds to volumes of 7.8 L, 18.78 L, and 44.3 L. The reactors considered all had a length of 730 mm, and the data was modeled based on water as the fluid in the reactor. As can be seen, the pressure drop increased as the diameter decreased.

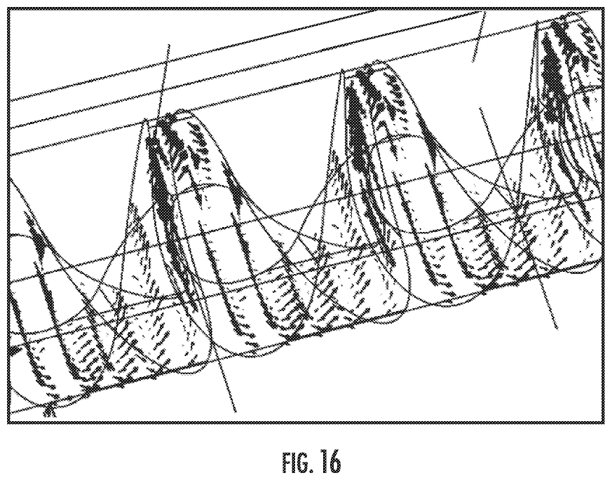

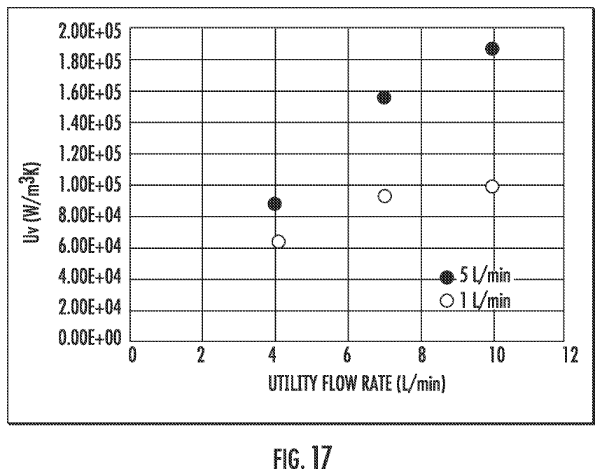

FIGS. 15 and 16 depict velocity field diagrams for two reactors 10 according to the present disclosure. The velocity field diagram of FIG. 15 corresponds to the embodiment depicted in FIG. 1. As can be seen, the helical channel 12 changes the direction and magnitude of the velocity vectors, indicating effective mixing of the fluid within the helical channel 12. The velocity field diagram of FIG. 16 corresponds to the embodiment depicted in FIG. 5 having a variable flow area. As can be seen, the increasing and decreasing flow area creates even larger changes in the magnitude of the velocity vectors, and the helical winding also changes the direction of the velocity vectors, which again demonstrates effective mixing within the helical channel 12.

Additionally, the intensity of heat transfer for an ethanol/silicone oil system (the latter designated as utility) was simulated adiabatically for a SiC reactor with 600 mL volume in each of the first helical channel 12 and the second helical channel 18. Each helical channel 12, 18 had a wall 22, 26 with a thickness of 5 mm. The intensity of heat transfer was found to be as high as 2.2×10⁵ W/m3K for 5 L/min ethanol and 15 L/min utility (with 50% in the central tube). For the same residence time, a reactor having about 65% smaller internal volume operated with 20 L/min utility, would have about 50% more intense heat transfer.

The impact of process fluid and total heat exchange fluid flow rate on the thermal performance of an SiC reactor with 0.6 L volume is shown in FIG. 17 for different total (second helical channel and central tube) heat exchange fluid flow rates (2+2 L/min; 5+2 L/min; 5+5 L/min) and two flow rates (5 L/min and 1 L/min) in the first helical channel for a toluene-silicone oil system. As expected, higher flowrates provided better thermal performance of the reactor.

### Experimental Examples

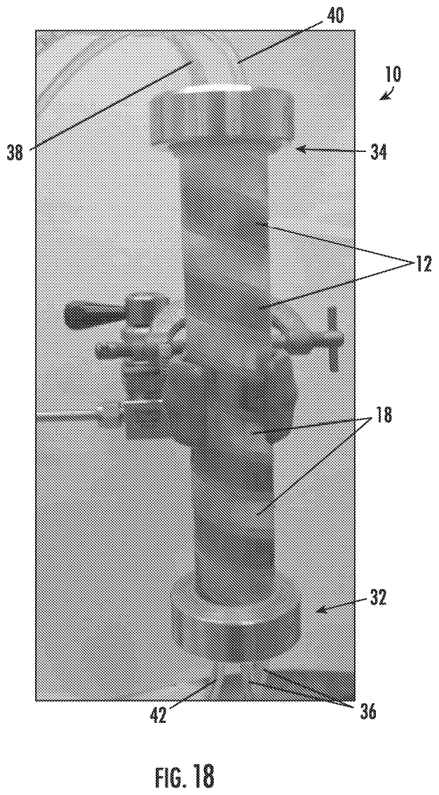

In addition to the modeled data, a prototype reactor 10 was also constructed as shown in FIG. 18. The reactor 10 had a first helical channel 12 with a volume of 28 mL. Two fluids were pumped into respective first inlets 36 of the first helical channel 12. One fluid had a yellow color, and one fluid had a blue color. It was observed that the fluid in the first helical channel 12 was green, indicating that the fluids were effectively mixed.

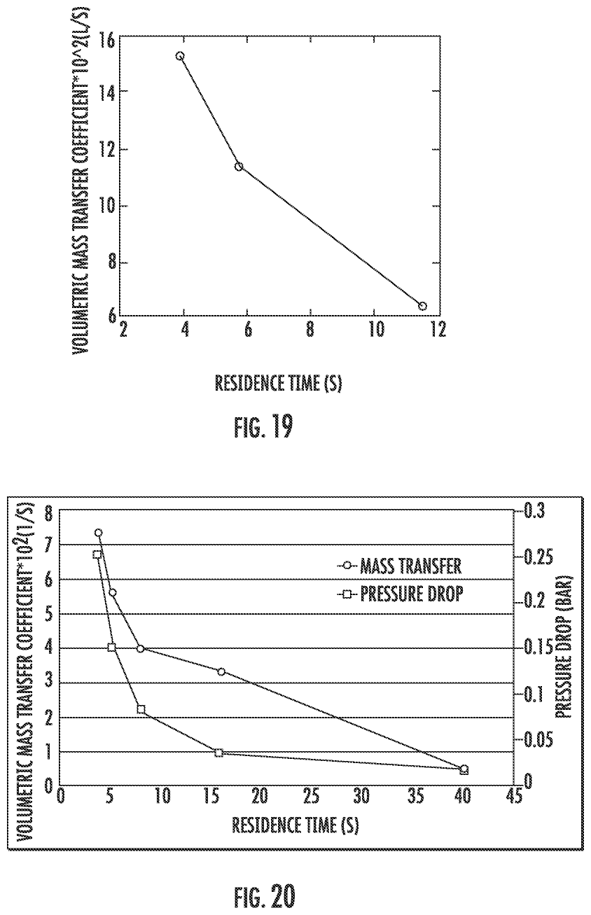

Using the reactor of FIG. 18, a gas-liquid system was investigated. In particular, the absorption of CO₂ in a 0.5 M NaHCO₃/Na₂CO₃ buffer solution was measured to determine the intensity of mass transfer. FIG. 19 depicts a graph of the volumetric mass transfer coefficient as a function of residence time. For a residence time of 4 seconds, the volumetric mass transfer coefficient was about 15.5·10⁻² s⁻¹, and for a residence time of about 12 seconds, the volumetric mass transfer coefficient was about 6·10⁻² s⁻¹. These values are in the range of what has been reported in the literature for various types of contactor technology. Further, it is believed that the intensity of the mass transfer process can be further enhanced using a membrane as described above in relation to FIG. 11.

In that regard, FIG. 20 graphs the volumetric mass transfer coefficient and pressure drop as a function of residence time from about 4 seconds to about 40 seconds. The volumetric mass transfer coefficient was measured for a device having a first helical channel 12 with a volume of 463 mL divided by a permeable membrane 70 into a first liquid passage 70 having a volume of 393 mL and a second gas passage 72 having a volume of 70 mL. The permeable membrane 70 had pores with a size as big as 7.86 mm. As shown in FIG. 20, the pressure drop is relatively low (only about 0.25 bar) even at low residence times (high flow rate).

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

The subject-matter of the disclosure may also relate, among others, to the following aspects:

According to aspect (1), a reactor is provided. The reactor comprises: a first helical channel comprising a plurality of first turns; a second helical channel comprising a plurality of second turns, the plurality of second turns of the second helical channel alternating with the plurality of first turns of the first helical channel; and a permeable membrane that divides the first helical channel into a first passage and a second passage along a length of the first helical channel; wherein the permeable membrane is configured to control a flow of fluid between the first passage and the second passage.

According to aspect (2), the reactor of aspect (1) is provided, wherein the first passage has a first cross-sectional flow area and the second passage has a second cross-sectional flow area and wherein the first and second cross-sectional flow areas vary along a length of the first helical channel.

According to aspect (3), the reactor of aspect (2) is provided, wherein the first cross-sectional flow area increases along the length of the first helical channel and the second cross-sectional flow area decreases along the length of the first helical channel.

According to aspect (4), the reactor of any one of aspects (1) to (3) is provided, further comprising a first inlet in fluid communication with the first passage and a second inlet in fluid communication with the second passage, wherein the first inlet is configured to receive first fluid and the second inlet is configured to receive a second fluid, and wherein the permeable membrane is configured to control a mixing of the second fluid in the first fluid.

According to aspect (5), the reactor of aspect (4) is provided, wherein the second helical channel comprises a third inlet configured to receive a heat exchange fluid.

According to aspect (6), the reactor of aspect (5) is provided, wherein the first inlet and the second inlet are disposed at a first end of the reactor and the third inlet is disposed at a second end of the reactor, the first end being opposite to the second end such that the flow of the first and second fluids through the first helical channel is counter-current to the flow of the heat exchange fluid through the second helical channel.

According to aspect (7), the reactor of any one of aspects (1) to (6) is provided, wherein the first helical channel is configured to vary a velocity field of fluid flowing through the first helical channel, wherein the velocity field is varied directionally and in magnitude.

According to aspect (8), the reactor of any one of aspects (1) to (7) is provided, wherein the first helical channel is defined by a first wall having a first outer surface, wherein the second helical channel is defined by a second wall having a second outer surface, and wherein the first outer surface is in contact with the second outer surface along the length of the first helical channel.

According to aspect (9), the reactor of any one of aspects (1) to (7) is provided, wherein the first helical channel comprises a first inner surface, wherein the second helical channel comprises a second inner surface, and wherein the first inner surface and the second inner surface share a common wall.

According to aspect (10), the reactor of any one of aspects (1) to (9) is provided, further comprising a central tube extending along a longitudinal axis of the reactor, wherein the first helical channel and the second helical channel wind around the central tube and wherein the central tube is configured to carry heat exchange fluid.

According to aspect (11), the reactor of any one of aspects (1) to (10) is provided, further comprising an outer shell disposed around the first helical channel and the second helical channel so as to form a cavity between the outer shell and the first and second helical channels, wherein the cavity is configured to carry heat exchange fluid.

According to aspect (12), the reactor of any one of aspects (1) to (11) is provided, further comprising at least one tap in fluid communication with the first helical channel, wherein the tap is configured to removed gases evolved during flow of fluid through the first helical channel.

According to aspect (13), the reactor of any one of aspects (1) to (12) is provided, further comprising a catalyst disposed within the first passage.

According to aspect (14), the reactor of aspect (13) is provided, wherein the catalyst is coated on an inner surface of the first passage.

According to aspect (15), the reactor of aspect (13) is provided, wherein the catalyst comprises a plurality of beads or pellets.

According to aspect (16), a reactor is provided. The reactor comprises: a first helical channel comprising a plurality of first turns; a second helical channel comprising a plurality of second turns, the plurality of second turns of the second helical channel alternating with the plurality of first turns of the first helical channel; and a catalyst disposed within the first helical channel; wherein the catalyst is configured to promote a reaction in fluid flowing through the first helical channel.

According to aspect (17), the reactor of aspect (16) is provided, wherein the catalyst is coated on an interior surface of the first helical channel.

According to aspect (18), the reactor of aspect (16) is provided, wherein the catalyst comprises a plurality of beads or pellets.

According to aspect (19), the reactor of any one of aspects (16) to (18) is provided, wherein the first helical channel is configured to vary a velocity field of fluid flowing through the first helical channel, wherein the velocity field is varied directionally and in magnitude.

According to aspect (20), the reactor of any one of aspects (16) to (19) is provided, wherein the first helical channel comprises a first cross-sectional flow area that varies along a length of the first helical channel.

According to aspect (21), the reactor of aspect (20) is provided, wherein the second helical channel comprises a second cross-sectional flow area that varies along a length of the second helical channel and wherein the second cross-sectional area varies inversely to the first cross-sectional area.

According to aspect (22), the reactor of any one of aspects (16) to (21) is provided, wherein the first helical channel is defined by a first wall having a first outer surface, wherein the second helical channel is defined by a second wall having a second outer surface, and wherein the first outer surface is in contact with the second outer surface along a length of first helical channel.

According to aspect (23), the reactor of any one of aspects (16) to (21) is provided, wherein the first helical channel comprises a first inner surface, wherein the second helical channel comprises a second inner surface, and wherein the first inner surface and the second inner surface share a common wall.

According to aspect (24), the reactor of any one of aspects (16) to (23) is provided, further comprising a first inlet in fluid communication with the first helical channel at a first end of the reactor, wherein the second helical channel comprises a second inlet configured to receive a heat exchange fluid, the second inlet disposed at a second end of the reactor opposite to the first end such that the flow of fluid through the first helical channel is counter-current to the flow of the heat exchange fluid through the second helical channel.

According to aspect (25), the reactor of any one of aspects (16) to (24) is provided, further comprising at least one tap in fluid communication with the first helical channel, wherein the tap is configured to remove gases evolved from the reaction in the fluid flowing through the first helical channel.

According to aspect (26), the reactor of any one of aspects (16) to (25) is provided, further comprising a central tube extending along a longitudinal axis of the reactor, wherein the first helical channel and the second helical channel wind around the central tube and wherein the central tube is configured to carry heat exchange fluid.

According to aspect (27), the reactor of any one of aspects (16) to (26) is provided, further comprising an outer shell disposed around the first helical channel and the second helical channel so as to form a cavity between the outer shell and the first and second helical channels, wherein the cavity is configured to carry heat exchange fluid.

According to aspect (28), the reactor of any one of aspects (16) to (27) is provided, further comprising a permeable membrane that divides the first helical channel into a first passage and a second passage along a length of the first helical channel, wherein the permeable membrane is configured to control a flow of fluid between the first passage and the second passage.

According to aspect (29), a system is provided. The system comprise two or more reactors according to any one of aspects (1) to (15) or (16) to (28) connected in series.

According to aspect (30), the system of aspect (29) is provided, wherein the two or more reactors comprise a first reactor and a second reactor, wherein the first reactor comprises a first pitch between the plurality of first turns, wherein the second reactor comprises a second pitch between the plurality of first turns, and wherein the first pitch is different from the second pitch.

According to aspect (31), the system of aspect (29) is provided, wherein the two or more reactors comprises a first reactor and a second reactor, wherein either or both the first reactor and the second reactor comprises a pitch that varies across the plurality of first turns.

According to aspect (32), the system of any one of aspects (29) to (31) is provided, wherein the plurality of first turns of the first reactor comprises a first maximum cross-sectional dimension, wherein the plurality of first turns of the second reactor comprises a second maximum cross-sectional dimension, and wherein the first maximum cross-sectional dimension is different from the second maximum cross-sectional dimension.

According to aspect (33), a method is provided. The method comprises: flowing a first fluid through a first helical channel that comprises a plurality of first turns winding around a longitudinal axis; flowing a second fluid through a second helical channel that comprises a plurality of second turns winding around the longitudinal axis, the plurality of second turns of the second helical channel alternating with the plurality of first turns of the first helical channel; catalyzing a reaction in the first fluid using a catalyst disposed in the first helical channel.

According to aspect (34), the method of aspect (33) is provided, wherein the catalyst is coated on an interior surface of the first helical channel.

According to aspect (35), the method of aspect (33) is provided, wherein the catalyst comprises a plurality of beads or pellets.

According to aspect (36), the method of any one of aspects (33) to (35) is provided, wherein flowing the first fluid further comprises varying a velocity field of the first fluid flowing through the first helical channel, wherein the velocity field is varied directionally and in magnitude.

According to aspect (37), the method of any one of aspects (33) to (36) is provided, wherein the first helical channel comprises a first cross-sectional flow area that varies along a length of the first helical channel.

According to aspect (38), the method of aspect (37) is provided, wherein the second helical channel comprises a second cross-sectional flow area that varies along a length of the second helical channel and wherein the second cross-sectional area varies inversely to the first cross-sectional area.

According to aspect (39), the method of any one of aspects (33) to (38) is provided, wherein the first helical channel is defined by a first wall having a first outer surface, wherein the second helical channel is defined by a second wall having a second outer surface, and wherein the first outer surface is in contact with the second outer surface along a length of first helical channel.

According to aspect (40), the method of any one of aspects (33) to (38) is provided, wherein the first helical channel comprises a first inner surface, wherein the second helical channel comprises a second inner surface, and wherein the first inner surface and the second inner surface share a common wall.

According to aspect (41), the method of any one of aspects (33) to (40) is provided, wherein flowing the second fluid further comprises flowing the second fluid in a flow direction counter to the first fluid.

According to aspect (42), the method of any one of aspects (33) to (41) is provided, further comprising removing gas evolved from the first fluid during flowing of the first fluid.

According to aspect (43), the method of any one of aspects (33) to (42) is provided, wherein flowing the second fluid further comprises using the second fluid to control a temperature of the first fluid.

According to aspect (44), the method of cany one of aspects (33) to (43) is provided, further comprising flowing a heat exchange fluid through a central tube extending along a longitudinal axis around which the first helical channel and the second helical channel wind.

According to aspect (45), the method of any one of aspects (33) to (44) is provided, further comprising controlling a temperature of the first fluid by flowing a heat exchange fluid in a cavity defined by an outer shell disposed around the first helical channel and the second helical channel.

According to aspect (46), the method of any one of aspects (33) to (45) is provided, wherein the first helical channel comprises a permeable membrane that divides the first helical channel into a first passage and a second passage along a length of the first helical channel, wherein method further comprises controlling a flow of a third fluid from the second passage into the first fluid from the first passage.

According to aspect (47), a method is provided. The method comprises: flowing a first fluid through a first passage of a first helical channel, the first helical channel comprising a plurality of first turns winding around a longitudinal axis; flowing a second fluid through a second passage of the first helical channel, wherein a permeable membrane separates the first passage from the second passage along a length of the first helical channel; flowing a third fluid through a second helical channel that comprises a plurality of second turns winding around the longitudinal axis, the plurality of second turns of the second helical channel alternating with the plurality of first turns of the first helical channel; and controlling a flow of the second fluid into the first fluid using the permeable membrane.

According to aspect (48), the method of aspect (47) is provided, wherein the first passage has a first cross-sectional flow area and the second passage has a second cross-sectional flow area and wherein the first and second cross-sectional flow areas vary along the length of the first helical channel.

According to aspect (49), the method of aspect (48) is provided, wherein the first cross-sectional flow area increases along the length of the first helical channel and the second cross-sectional flow area decreases along the length of the first helical channel.

According to aspect (50), the method of any one of aspects (47) to (49) is provided, wherein flowing the first fluid further comprises varying a velocity field of the first fluid flowing through the first passage of the first helical channel, wherein the velocity field is varied directionally and in magnitude.

According to aspect (51), the method of any one of aspects (47) to (50) is provided, wherein the first helical channel is defined by a first wall having a first outer surface, wherein the second helical channel is defined by a second wall having a second outer surface, and wherein the first outer surface is in contact with the second outer surface along a length of first helical channel.

According to aspect (52), the method of any one of aspects (47) to (50) is provided, wherein the first helical channel comprises a first inner surface, wherein the second helical channel comprises a second inner surface, and wherein the first inner surface and the second inner surface share a common wall.

According to aspect (53), the method of any one of aspects (47) to (52) is provided, wherein flowing the third fluid further comprises flowing the second fluid in a flow direction counter to the first fluid.

According to aspect (54), the method of any one of aspects (47) to (53) is provided, further comprising removing gas evolved from the first fluid during flowing of the first fluid.

According to aspect (55), the method of any one of aspects (47) to (54) is provided, wherein flowing the third fluid further comprises using the third fluid to control a temperature of the first fluid.

According to aspect (56), the method of cany one of aspects (47) to (55) is provided, further comprising flowing a heat exchange fluid through a central tube extending along a longitudinal axis around which the first helical channel and the second helical channel wind.

According to aspect (57), the method of any one of aspects (47) to (56) is provided, further comprising controlling a temperature of the first fluid by flowing a heat exchange fluid in a cavity defined by an outer shell disposed around the first helical channel and the second helical channel.

According to aspect (58), the method of any one of aspects (47) to (57) is provided, wherein the first helical channel comprises a catalyst disposed in the first passage and wherein the method further comprises catalyzing a reaction in the first fluid using the catalyst.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

1. A reactor, comprising:
a first helical channel comprising a plurality of first turns;
a second helical channel comprising a plurality of second turns, the plurality of second turns of the second helical channel alternating with the plurality of first turns of the first helical channel; and
a permeable membrane that divides the first helical channel into a first passage and a second passage along a length of the first helical channel;
wherein the permeable membrane is configured to control a flow of fluid between the first passage and the second passage.

2. The reactor of claim 1, wherein the first passage has a first cross-sectional flow area and the second passage has a second cross-sectional flow area and wherein the first and second cross-sectional flow areas vary along a length of the first helical channel and wherein the first cross-sectional flow area increases along the length of the first helical channel and the second cross-sectional flow area decreases along the length of the first helical channel.

3. (canceled)

4. The reactor of claim 1, further comprising a first inlet in fluid communication with the first passage and a second inlet in fluid communication with the second passage, wherein the first inlet is configured to receive a first fluid and the second inlet is configured to receive a second fluid, and wherein the permeable membrane is configured to control a mixing of the second fluid in the first fluid.

5. The reactor of claim 4, wherein the second helical channel comprises a third inlet configured to receive a heat exchange fluid and wherein the first inlet and the second inlet are disposed at a first end of the reactor and the third inlet is disposed at a second end of the reactor, the first end being opposite to the second end such that the flow of the first and second fluids through the first helical channel is counter-current to the flow of the heat exchange fluid through the second helical channel.

6. (canceled)

7. The reactor claim 1, wherein the first helical channel is configured to vary a velocity field of fluid flowing through the first helical channel, wherein the velocity field is varied directionally and in magnitude.

8. The reactor of claim 1, wherein the first helical channel is defined by a first wall having a first outer surface, wherein the second helical channel is defined by a second wall having a second outer surface, and wherein the first outer surface is in contact with the second outer surface along the length of the first helical channel.

9. The reactor of claim 1, wherein the first helical channel comprises a first inner surface, wherein the second helical channel comprises a second inner surface, and wherein the first inner surface and the second inner surface share a common wall.

10. The reactor of claim 1, further comprising a central tube extending along a longitudinal axis of the reactor, wherein the first helical channel and the second helical channel wind around the central tube and wherein the central tube is configured to carry heat exchange fluid.

11. The reactor of claim 1, further comprising an outer shell disposed around the first helical channel and the second helical channel so as to form a cavity between the outer shell and the first and second helical channels, wherein the cavity is configured to carry heat exchange fluid.

12. The reactor of claim 1, further comprising at least one tap in fluid communication with the first helical channel, wherein the at least one tap is configured to removed gases evolved during flow of fluid through the first helical channel.

13. The reactor of claim 1, further comprising a catalyst disposed within the first passage.

14. The reactor of claim 13, wherein the catalyst is coated on an inner surface of the first passage.

15. The reactor of claim 13, wherein the catalyst comprises a plurality of beads or pellets.

16. A reactor, comprising:
a first helical channel comprising a plurality of first turns;
a second helical channel comprising a plurality of second turns, the plurality of second turns of the second helical channel alternating with the plurality of first turns of the first helical channel; and
a catalyst disposed within the first helical channel;
wherein the catalyst is configured to promote a reaction in fluid flowing through the first helical channel.

17-28. (canceled)

29. A system, comprising two or more reactors according to claim 1 connected in series.

30. The system of claim 29, wherein the two or more reactors comprise a first reactor and a second reactor, wherein the first reactor comprises a first pitch between the plurality of first turns, wherein the second reactor comprises a second pitch between the plurality of first turns, and wherein the first pitch is different from the second pitch.

31. The system of claim 29, wherein the two or more reactors comprises a first reactor and a second reactor, wherein either or both the first reactor and the second reactor comprises a pitch that varies across the plurality of first turns wherein the plurality of first turns of the first reactor comprises a first maximum cross-sectional dimension, wherein the plurality of first turns of the second reactor comprises a second maximum cross-sectional dimension, and wherein the first maximum cross-sectional dimension is different from the second maximum cross-sectional dimension.

32-46. (canceled)

47. A method, comprising:
flowing a first fluid through a first passage of a first helical channel, the first helical channel comprising a plurality of first turns winding around a longitudinal axis;
flowing a second fluid through a second passage of the first helical channel, wherein a permeable membrane separates the first passage from the second passage along a length of the first helical channel;
flowing a third fluid through a second helical channel that comprises a plurality of second turns winding around the longitudinal axis, the plurality of second turns of the second helical channel alternating with the plurality of first turns of the first helical channel; and
controlling a flow of the second fluid into the first fluid using the permeable membrane.

48. The method of claim 47, wherein the first passage has a first cross-sectional flow area and the second passage has a second cross-sectional flow area and wherein the first and second cross-sectional flow areas vary along the length of the first helical channel and wherein the first cross-sectional flow area increases along the length of the first helical channel and the second cross-sectional flow area decreases along the length of the first helical channel.

49-50. (canceled)

51. The method of claim 47, wherein the first helical channel is defined by a first wall having a first outer surface, wherein the second helical channel is defined by a second wall having a second outer surface, and wherein the first outer surface is in contact with the second outer surface along a length of first.

52-58. (canceled)
